(19) United States
(12) Patent Application Publication
(10) Pub. No.: US 2020/0278174 A1
(43) Pub. Date: Sep. 3, 2020

(54) TACTICAL VEST SYSTEM AND METHOD FOR POWERING AN ELECTRONIC DEVICE ON A RIFLE

(71) Applicant: SOURCE VAGABOND SYSTEMS LTD., Tirat Carmel (IL)

(72) Inventors: Yoram GILL, EIN HOD (IL); Gal BEN-ARAV, Kfar-Yuval (IL); Roi KARP, Ganot Hadar (IL)

(73) Assignee: SOURCE VAGABOND SYSTEMS LTD., Tirat Carmel (IL)

(21) Appl. No.: 16/645,833

(22) PCT Filed: Sep. 4, 2018
(86) PCT No.: PCT/IL2018/050982

§ 371 Date: Mar. 10, 2020

(30) Foreign Application Priority Data
Sep. 11, 2017 (IL) 254420

(51) Int. Cl. F41C 27/00; F41C 33/00; F41C 23/02; F41H 1/02; A41D 1/00

(52) U.S. Cl. CPC F41C 27/00; F41C 33/002; F41G 3/00; F41H 1/02; A41D 1/002; F41C 23/02

(57) ABSTRACT

A tactical vest system may include: a tactical vest; a power unit connected or connectable to the vest comprising a power supply; a sling connected or connectable to the vest for connecting to a rifle and suspending the rifle from a shoulder a user wearing the vest; and an electrical wire connected or connectable at one end of the wire to the power unit and connected or connectable at another end of the wire to electronic device mounted on the rifle, to provide power to the electronic device.

### FIELD OF THE INVENTION

The present invention relates to a tactical vest system for powering an electronic device mounted on or incorporated in a rifle.

### BACKGROUND OF THE INVENTION

Tactical vests, e.g., bullet-proof vests, body armor, flak jackets and other such vests (hereinafter referred to generally as “tactical vests”) typically include a textile vest in or on which various loads are provided.

An infantry soldier, depending on the nature of a particular task or mission, may be required to carry weapons, ammunition, water, food, body armor, tools, communication equipment, and reconnaissance equipment, all of which are included or are appended on his tactical vest. The weight of this equipment may, in some cases, be similar to the weight of the body of the person carrying the load.

Rifles are used by soldiers (e.g., infantry soldiers), security personnel, hunters, sports shooters, and others. In order for the rifle to be accurately aimed at a target and avoid pain or injury due to recoil, the rifle must be held properly. It is generally recommended that, when a rifle is properly held, the butt of a rifle should be firmly placed where the upper arm joins the shoulder. This position is often referred to as the shoulder pocket. The heavier the rifle, the more burden on the soldier's arms, increasing muscle fatigue and consequently reducing the soldier's performance, and in particular degrading the soldier's marksmanship performance.

Recently, smart rifles were introduced, that include electronic devices for enhancing various features and capabilities. Such electronic devices require power source that is typically also mounted on the rifle, further increasing the overall weight of the rifle.

### SUMMARY OF THE INVENTION

There is thus provided, in accordance with an embodiment of the present invention, a tactical vest system. The tactical vest system may include a tactical vest; a power unit connected or connectable to the vest comprising a power supply; a sling connected or connectable to the vest for connecting to a rifle and suspending the rifle from a shoulder a user wearing the vest; and an electrical wire connected or connectable at one end of the wire to the power unit and connected or connectable at another end of the wire to electronic device mounted on the rifle, to provide power to the electronic device.

In some embodiments of the present invention, the sling is coupled to a buckle configured to engage the sling to the rifle or disengage the sling from the rifle.

In some embodiments of the present invention, the electrical wire is provided with an electrical connector at a distal end for connecting to the electronic device or to a corresponding connector of the electronic device.

According to some embodiments of the present invention, the sling is coupled to a buckle configured to engage the sling to the rifle or disengage the sling from the rifle, and wherein the buckle and the electrical connector are rigidly coupled.

According to some embodiments of the present invention, the buckle comprises a snap-in quick-release buckle.

According to some embodiments of the present invention, the electrical connector is formed of a socket and a corresponding plug.

According to some embodiments of the present invention, the wire passes via a void in the sling.

According to some embodiments of the present invention, the sling is connected or connectable to a back of the vest so as to pass over a shoulder of the vest.

According to some embodiments of the present invention, the power unit comprises a communication module for communicating data from the electronic device to a remote device or for communicating data from the remote device to the electronic device.

There is also provided, in accordance with some embodiments of the present invention a method for powering an electronic device mounted on a rifle. The method may include providing a tactical vest. The method may also include connecting a power unit to the vest, the power unit comprising a power supply. The method may further include connecting a sling to the vest and connecting the sling to the rifle and suspending the rifle from a shoulder a user wearing the vest. The method may also include providing an electrical wire connected at one end of the wire to the power unit and connected at another end of the wire to the electronic device mounted on the rifle, to provide power to the electronic device.

There is also provided, in accordance with some embodiments of the invention a tactical vest system that includes a tactical vest; a data communication unit connected or connectable to the vest comprising a wireless data transceiver; a sling connected or connectable to the vest for connecting to a rifle and suspending the rifle from a shoulder of a user wearing the vest; and an electrical wire connected or connectable at one end of the wire to the data unit and connected or connectable at another end of the wire to electronic device mounted on the rifle, to transmit data received from a remote unit via the data communication unit to the electronic device or to transmit data from the electronic device via the data communication unit to the remote unit.

### BRIEF DESCRIPTION OF THE DRAWINGS

In order for the present invention, to be better understood and for its practical applications to be appreciated, the following Figures are provided and referenced hereafter. It should be noted that the Figures are given as examples only and in no way limit the scope of the invention. Like components are denoted by like reference numerals.

FIG. 1 shows a an infantry soldier wearing a tactical vest with power unit and a sling with a power wire for powering a rifle with electronic aiming system, according to some embodiments of the present invention;

FIG. 2 shows a sling with a power wire for use for connecting a power unit of a tactical vest to a rifle with an electronic device, according to some embodiments of the present invention;

FIG. 3A illustrates a combined buckle and electrical connector for a power cord, for incorporation with a tactical vest with power unit for powering a rifle with an electronic device, according to some embodiments of the present invention, in a disengaged state;

FIG. 3B illustrates the combined buckle and electrical connector of FIG. 3A, in an engaged state;

FIG. 3C is a front view of a female part of the combined buckle and electrical connector of FIGS. 3A and 3B, according to some embodiments of the present invention;

FIG. 4 is a schematic illustration of a power/data communication unit, for incorporation with a tactical vest for powering rifle with an electronic device and for communicating data to or from the electronic device, according to some embodiments of the present invention.

### DETAILED DESCRIPTION OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, the conjunction “or” as used herein is to be understood as inclusive (any or all of the stated options).

When entering into a firing position, snipers rely on the strength of their muscles to hold their rifle steadily, in order to accurately aim and hit their target. This is true for any shooter, but for infantry soldiers, who often carry heavy loads and are wearing tactical vests that affect their maneuverability, the strain on the soldier's muscles is substantially greater. A fatigued soldier's chances of hitting a target may be greatly reduced.

Electronic devices may be installed on a rifle. For example, recently an electronic aiming system for rifles was introduced (see, for example, U.S. Patent Application Publication No. 2014/0028856 (Ehrlich)). The introduction of such system, while possibly increasing the marksmanship accuracy of the soldier increases the weight of the rifle. Other electronic devices that may be installed on a rifle, such as, night-vision optics, laser pointers, and other electronic devices.

It is an object of some embodiments of the present invention to provide a tactical vest with a power unit and a power link for connecting to a rifle with an electronic. Providing such a tactical vest may reduce the weight of the rifle by removing the power supply from the rifle and placing it on the tactical vest. Other objectives of some embodiments of the present invention will become apparent after reading the present specification and reviewing the appended drawings.

Reference is now made to the figures.

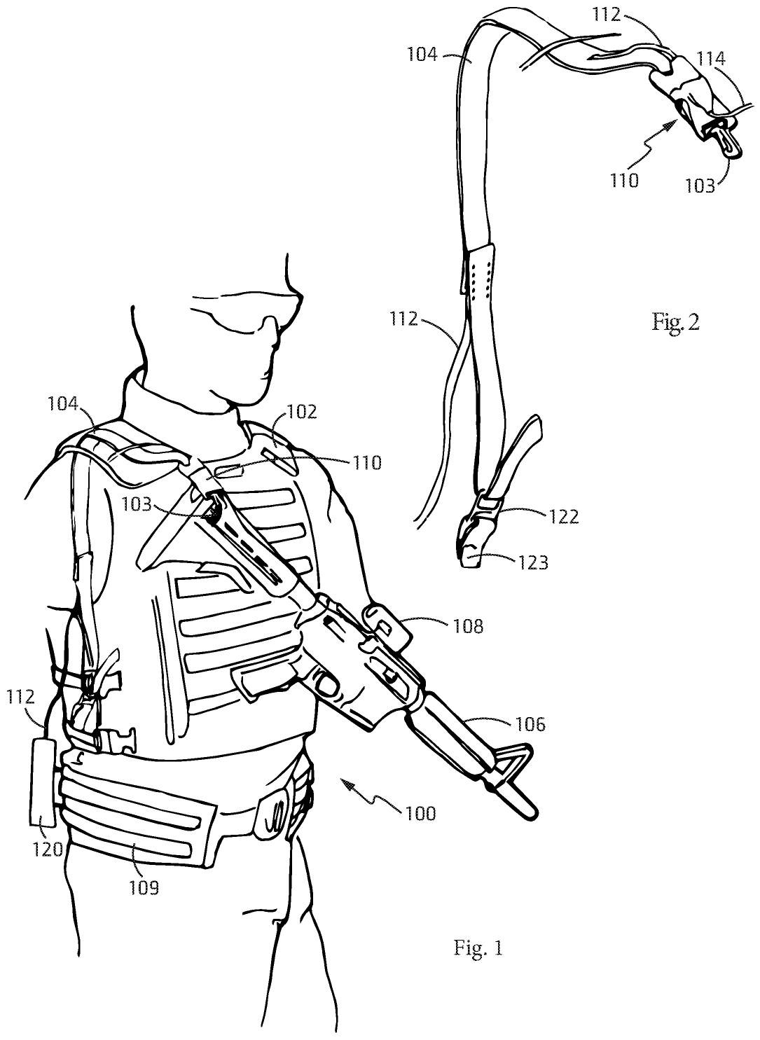

FIG. 1 shows an infantry soldier wearing a tactical vest system 100 with power unit 120 and a sling 104 connected at a proximal end of the sling to the vest 102, for supporting a rifle 106.

FIG. 2 shows a sling with a power wire for use for connecting a power unit of a tactical vest to a rifle with an electronic device, according to some embodiments of the present invention.

Tactical vest system 100 may include a tactical vest 102, designed to be worn by a person (e.g., a soldier, a policeman or any other security personnel). Tactical vest 102 may include ballistic protection plates (not shown in this figures), and may also be configured to support a load or loads (e.g., backpack, equipment bag, ammunition, tools, water jerrican, communication device, etc., not shown in this figure).

Sling 104 may include a base portion 123 that is connected or connectable to the vest. An adjusting link 122 may be provided to allow convenient adjusting of the length of the sling, to the user's liking. Sling 104 may be connected to the vest on the back, substantially extending across the back and over the shoulder. In other embodiments of the invention the sling may be connected to another part of the vest. Passing the sling over the shoulder and having an end of the sling hang in front of the vest allows engaging a rifle to the sling and suspend the rifle over the shoulder and in front of the wearer of the vest. Sling 104 may be made of a durable strong textile, such as, for example, nylon fabric (e.g., Cordura™ fabric).

Sling 104 may include a power wire 112 which is connected or connectable to power unit 120 and extends along sling 104 (e.g., over the sling or in a void within the sling) to a distal end of the sling, ending at a physical/electrical connector 110. Power unit 120 may be removably connected to vest 102, so as to allow removal and replacement of the power unit.

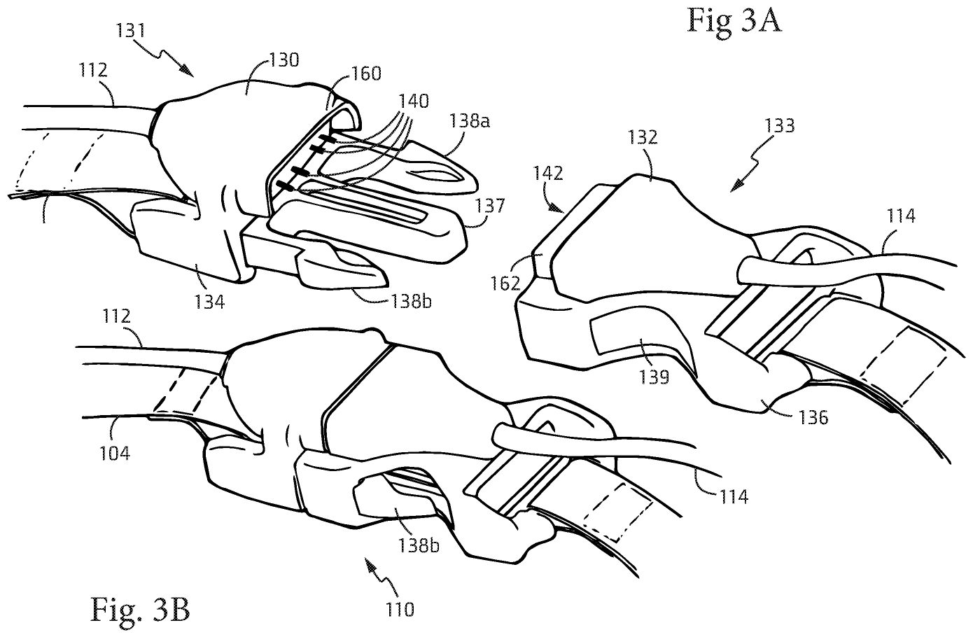

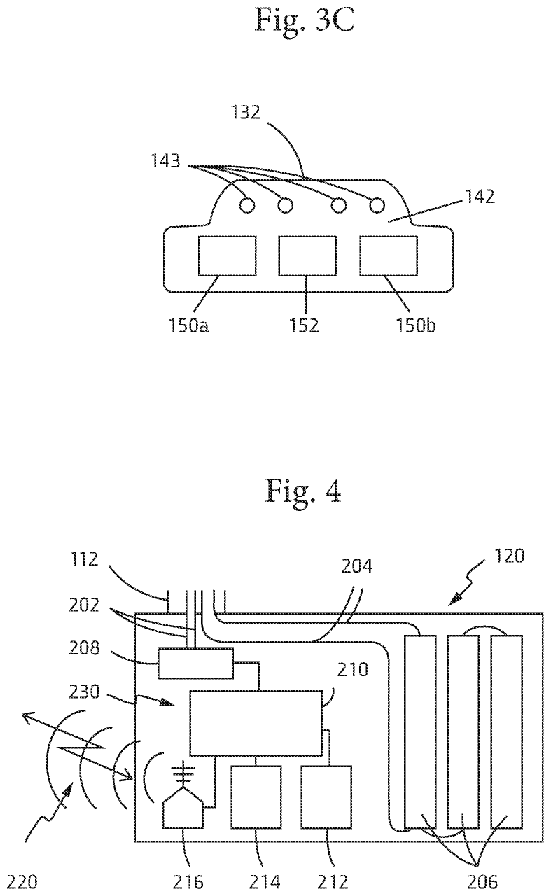

FIG. 3A illustrates a combined buckle and electrical connector for a power cord, for incorporation with a tactical vest with power unit for powering a rifle with an electronic device, according to some embodiments of the present invention, in a disengaged state.

FIG. 3B illustrates the combined buckle and electrical connector of FIG. 3A, in an engaged state.

Combined buckle and electrical connector 110, according to some embodiments of the invention, is designed to perform two tasks. Connector 110 may be designed to firmly support rifle 106, e.g., via shackle 103 that is coupled to connector 110 and designed to be coupled to rifle 106, for example, at the butt of the rifle. Connector 110 may be also designed to electrically couple electrical wire 112 to a proximal end of wire 114 that is connected at its distal end to the electronic device on the rifle (e.g., 108 in FIG. 1).

According to some embodiments of the invention, connector 110 may include two corresponding parts 131 and 133 designed to engage and disengage. For example, connector part 131 may include two sectors 134 and 130, forming a snap-in quick-release buckle, arranged in a substantially arrangement, where sector 134 includes dented bars 138a and 138b, which are designed to engage with corresponding sector 136 of connector part 133 by snapping into dented bores inside sector 136 (see also FIG. 3C and corresponding explanation), and a central lead bar 137, designed to be inserted into a corresponding central bore inside connector sector 136, for added rigidity and stability. When snapped into engagement, each of dented bars 138a and 138b protrudes through concave openings 139 so as to allow a user to press the dented bars 138a and 138b into the openings 139 and pull connector 110 open.

The electrical link may be realized by sectors 130 and 132 that form plug and corresponding socket through which power is supplied from power unit 120 to the electronic device 108 on rifle 106. For example, socket sector 130 may include pins 140 (e.g. positive and negative polarity pins for power transfer, and data transfer pins).

FIG. 3C is a front view of a female part of the combined buckle and electrical connector of FIGS. 3A and 3B, according to some embodiments of the present invention.

Plug pins 140 may be designed to be inserted into corresponding socket bores 143 on face 142 of socket sector 132. For enhanced engagement, shoulder 162 of socket sector 132 may be designed to fit inside corresponding void defined by rim 160 on plug sector 130.

The design of connector 110 may be aimed at providing a rigid physical connection as well as effective electrical connection, both of which may be realized independently, in the sense that the electrical connection is not subjected to physical strain resulting from the physical loads that the physical part of the connector is designed to bear, for example, according to the design of connector 110 depicted in the figures, or according to appropriate alternative designs. Such design may increase the reliability of the connector 110. Bores 150a and 150b are designed to accommodate dented bars 138a and 138b respectively, and bore 152 is designed to accommodate central bar 137.

Thus. Sling 104 may serve as a sling to which rifle 106 may be coupled. The rifle may be allowed to be freely suspended from the vest, thus freeing the soldier's hands. When necessary, the soldier may hold the rifle and raise it to a shooting position quickly and conveniently. During all of that time the electronic device 108 may be electrically connected to power unit 120 via the electrical wire 112,114 of sling 104.

FIG. 4 is a schematic illustration of a power/data communication unit, for incorporation with a tactical vest for powering rifle with an electronic device and for communicating data to or from the electronic device, according to some embodiments of the present invention.

Power unit 120 may include one or a plurality of batteries 206, which are designed to store electrical energy and provide that energy via the power wire (e.g., 112, 114) to the electronic device (108) mounted on the rifle (106). The electrical power is supplied over wires 204 that are part of wire 112. Batteries 206 may be replaceable or rechargeable.

Power unit may be removable and replaceable, and wire 112 may be connected to power unit 120 via a connector, so as to allow engagement and disengagement and removal and replacing of the power unit.

According to some embodiments of the invention, power unit 120 may also include a communication module 230, for communicating data to or from the electronic device 108 of the rifle 106 to a remote transmitter/receiver (not shown in this figure).

In some embodiments of the present invention communication module 230 may include an input/output interface 208 for forwarding or receiving date from or to electronic device 108 via data lines 202, a processor 210, memory 212 (e.g., storage device, and/or random access memory—RAM), display 214 and wireless transceiver 216 for wirelessly communicating 220 data to and from a remote device. For example the communication module may transmit to the remote device image data form an electronic imaging device mounted on the rifle. In another example, the communication module may transmit to the remote device data on the rifle performance (e.g., how many rounds were fired), location data relating to a current location of the rifle from a GPS or other positioning system sensor mounted on the rifle, etc. Wireless transceiver may be designed for one or a plurality of communication types, such as, for example, radio frequency (RF) communication, wi-fi communication, Bluetooth communication, etc.

In some other embodiments of the invention, the communication module may be used for receiving data from the remote device, to be used by the electronic device mounted on the rifle. For example, the rifle may require a remote authorization to actively fire, and such authorization may be transmitted from the remote device to the communication module and forwarded to the electronic device on the rifle that prevents or facilitates firing.

Different embodiments are disclosed herein. Features of certain embodiments may be combined with features of other embodiments; thus certain embodiments may be combinations of features of multiple embodiments. The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A tactical vest system comprising:
a tactical vest;
a power unit connected or connectable to the vest comprising a power supply;
a sling connected or connectable to the vest for connecting to a rifle and suspending the rifle from a shoulder of a user wearing the vest; and
an electrical wire connected or connectable at one end of the wire to the power unit and connected or connectable at another end of the wire to electronic device mounted on the rifle, to provide power to the electronic device.

2. The system of claim 1, wherein the sling is coupled to a buckle configured to engage the sling to the rifle or disengage the sling from the rifle.

3. The system of claim 1, wherein the electrical wire is provided with an electrical connector at a distal end for connecting to the electronic device or to a corresponding connector of the electronic device.

4. The system of claim 3, wherein the sling is coupled to a buckle configured to engage the sling to the rifle or disengage the sling from the rifle, and wherein the buckle and the electrical connector are rigidly coupled.

5. The system of claim 4, wherein the buckle comprises a snap-in quick-release buckle.

6. The system of claim 4, wherein the electrical connector is formed of a socket and a corresponding plug.

7. The system of claim 1, wherein the wire passes via a void in the sling.

8. The system of claim 1, wherein the sling is connected or connectable to a back of the vest so as to pass over a shoulder of the vest.

9. The system of claim 1, wherein the power unit comprises a communication module for communicating data from the electronic device to a remote device or for communicating data from the remote device to the electronic device.

10. A method for powering an electronic device mounted on a rifle, the method comprising:
providing a tactical vest
connecting a power unit to the vest, the power unit comprising a power supply;
connecting a sling to the vest and connecting the sling to the rifle and suspending the rifle from a shoulder of a user wearing the vest;
providing an electrical wire connected at one end of the wire to the power unit and connected at another end of the wire to the electronic device mounted on the rifle, to provide power to the electronic device.

11. The method of claim 10, further comprising coupling the sling to a buckle configured to engage the sling to the rifle or to disengage the sling from the rifle.

12. The method of claim 10, further comprising providing the electrical wire with an electrical connector at a distal end for connecting to the electronic device or to a corresponding connector of the electronic device.

13. The method of claim 12, further comprising coupling the sling to a buckle configured to engage the sling to the rifle or disengage the sling from the rifle, and wherein the buckle and the electrical connector are rigidly coupled.

14. The method of claim 13, wherein the buckle comprises a snap-in quick-release buckle.

15. The method of claim 13, wherein the electrical connector is formed of a socket and a corresponding plug.

16. The method of claim 10, further comprising passing the wire via a void in the sling.

17. The method of claim 10, further comprising connecting the sling to a back of the vest so as to pass over a shoulder of the vest.

18. The method of claim 10, wherein the power unit comprises a communication module, the method further comprising communicating data from the electronic device to a remote device or communicating data from the remote device to the electronic device.

19. A tactical vest system comprising:
a tactical vest;
a data communication unit connected or connectable to the vest comprising a power supply;
a sling connected or connectable to the vest for connecting to a rifle and suspending the rifle from a shoulder of a user wearing the vest; and
an electrical wire connected or connectable at one end of the wire to the data unit and connected or connectable at another end of the wire to electronic device mounted on the rifle, to transmit data received from a remote unit via the data communication unit to the electronic device or to transmit data from the electronic device via the data communication unit to the remote unit.
